(19) United States
(12) Patent Application Publication
(10) Pub. No.: US 2018/0183769 A1
(43) Pub. Date: Jun. 28, 2018

(54) CONTROL SYSTEM AND CONTROL METHOD

(71) Applicant: NDUSTRIAL TECHNOLOGY RESEARCH INSTITUTE, Hsinchu (TW)

(72) Inventors: Bo-Lin SUNG, Hsinchu City (TW); Yung-Chen WANG, Zhubei City (TW)

(73) Assignee: INDUSTRIAL TECHNOLOGY RESEARCH INSTITUTE, Hsinchu (TW)

(21) Appl. No.: 15/842,677

(22) Filed: Dec. 14, 2017

(30) Foreign Application Priority Data
Dec. 23, 2016 (TW) 105143050

(51) Int. Cl. H04L 29/06; G05B 15/02; H04L 9/32; H04L 9/08

(52) U.S. Cl. CPC H04L 63/0471; G05B 15/02; H04L 9/0825; H04L 9/3247; H04L 63/0442

(57) ABSTRACT

A control system comprises a server and a gateway. The server is configured to encrypt a control signal according to a public key for generating a first encrypted signal. The gateway is electrically connected to a local controller, wherein the local controller controls an electronic device according to at least one parameter, and communicate with the local controller via a controller area network (CAN). The gateway is configured to decrypt the first encrypted signal according to a first private key for obtaining the control signal, and obtain the at least one parameter of the local controller for generating a monitoring signal according to the control signal, or the gateway is configured to instruct the local controller to adjust the at least one parameter according to the control signal, wherein the first private key and the first public key belong to a same pair of keys.

### CROSS REFERENCE TO RELATED APPLICATION

This application claims the priority benefits of Taiwan application No. 105143050, entitled “CONTROL SYSTEM AND CONTROL METHOD”, and filed on Dec. 23, 2016. The entirety of which is incorporated by reference herein.

### TECHNICAL FIELD

The present disclosure relates to a control system and a control method.

### BACKGROUND

Nowadays, some tooling devices may block parts of the system, so that general users fail to access the parts directly. This prevents the non-professional users from setting irrational parameter values that result in the damage of the tooling devices or even make a danger happen. Usually, a specialized calibration tool is required for the calibration of such kinds of tooling devices.

For vehicle calibration tools, the standard calibration tools currently in the markets are developed on a computer-based foundation in order to make the calibration highly instant and fast. However, when the computer-based foundation is used, the user needs to manually operate many steps, such as installing programs and setting a program environment. In addition, it is also a big trouble for the user to use physical wires or circuitry required by computers.

There are many web-based foundations that display in-vehicle information. However, these techniques typically require corresponding and specialized programs written for the use of tuning ends. Besides, most web-based foundations show in-vehicle information by using non-real-time methods. However, nor can it use a systematic way to calibrate the parameters, but also accompanies with the data transmission security issues.

### SUMMARY

The present disclosure provides a control system and a control method to overcome the problems of non-real-time monitoring, systematic calibration, and data transmission security in the past.

In an embodiment of the present disclosure, a control system is provided. The control system comprises a server and a gateway. The server is configured to encrypt a control signal according to a public key for generating a first encrypted signal. The gateway is electrically connected to a local controller. Wherein the local controller controls an electronic device according to at least one parameter. Wherein the gateway is configured to communicate with the local controller via a controller area network (CAN). The gateway is configured to decrypt the first encrypted signal according to a first private key for obtaining the control signal and obtain the at least one parameter of the local controller for generating a monitoring signal according to the control signal, or the gateway is configured to instruct the local controller for adjusting the at least one parameter according to the control signal. Wherein the first private key and the first public key belong to a same pair of keys.

In an embodiment of the present disclosure, a control method applied to a control system is provided. The control method is applied to a control system having a server and a gateway. Wherein the gateway is configured to communicate with a local controller via a controller area network. The control method comprises encrypting, by the server, a control signal according to a first public key for generating a first encrypted signal; decrypting, by the gateway, the first encrypted signal according to a first private key for obtaining the control signal; and obtaining, by the gateway, the at least one parameter of the local controller according to the control signal for generating a monitoring signal, or instructing the local controller, by the gateway, to adjust the at least one parameter according to the control signal. Wherein the first private key and the first public key belong to a same pair of keys.

The foregoing will become better understood from a careful reading of a detailed description provided herein below with appropriate reference to the accompanying drawings.

### BRIEF DESCRIPTION OF THE DRAWINGS

FIG. 1 is a functional block diagram of a control system in accordance with an embodiment of the present disclosure.

FIG. 2 is a schematic diagram of the operation of the control system in accordance with an embodiment of the present disclosure.

FIG. 3 is a flowchart illustrating a control method in accordance with an embodiment of the present disclosure.

### DETAILED DESCRIPTION OF DISCLOSED EMBODIMENTS

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

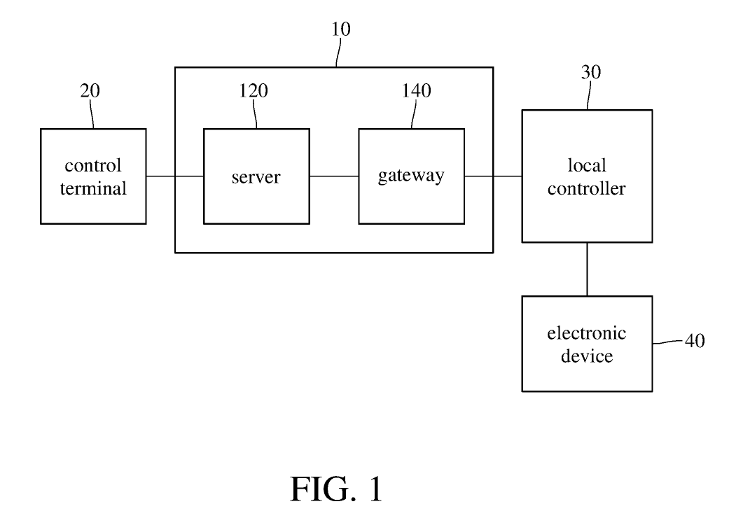

FIG. 1 is a functional block diagram of a control system in accordance with an embodiment of the present disclosure. As shown in FIG. 1, a control system 10 comprises a server 120 and a gateway 140. The server 120 is configured to communicate with the gateway 140 by a wired or a wireless manner. The gateway 140 is electrically connected to a local controller 30. In an embodiment, the gateway 140 communicates with the local controller 30 via a controller area network (CAN).

The server 120 encrypts a control signal according to a first public key to generate a first encrypted signal. The control signal, for example, comes from a control terminal 20. The control terminal 20 is, for example, a user's cellular phone, a tablet, a laptop, or other electronic devices having processing ability. In an embodiment, the server 120 is configured to provide webpages of control interface. The control terminal 20 is configured to access the webpages of the control interface and provide the control signal to the control terminal 20 via the webpages of the control interface. In practice, the number of the control terminals 20 may be one or more, depending on the number of links that can be supported by the webpages of the control interface or the number of links that can be supported by the interfaces provided by the server 120. But the scope of the disclosure is not limited thereto.

The local controller 30 controls an electronic device 40 according to at least one parameter. The gateway 140 is configured to obtain the at least one parameter of the local controller 30 according to the control signal to generate a monitoring signal. Alternatively, the gateway 140 is configured to instruct the local controller 30 to adjust the at least one parameter according to the control signal. In an embodiment, the electronic device 40 is, for example, a vehicle. In practice, the local controller 30 may be a controller equipped in the electronic device 40. Alternatively, the local controller 30 may be a product independent from the electronic device 40. The at least one parameter is, for example, an engine parameter, a gearbox parameter, or a tire pressure.

The above examples are illustrative, but the scope of the disclosure is not limited thereto.

The gateway 140 is configured to decrypt the first encrypted signal according to a first private key to obtain a control signal. The first private key and the first public key belong to a same pair of keys. That is to say, the first private key can be used to decrypt the data encrypted by the first public key. The first public key can also be used to verify the data digitally signed by the first private key. But the algorithm used for the keys is not limited thereto.

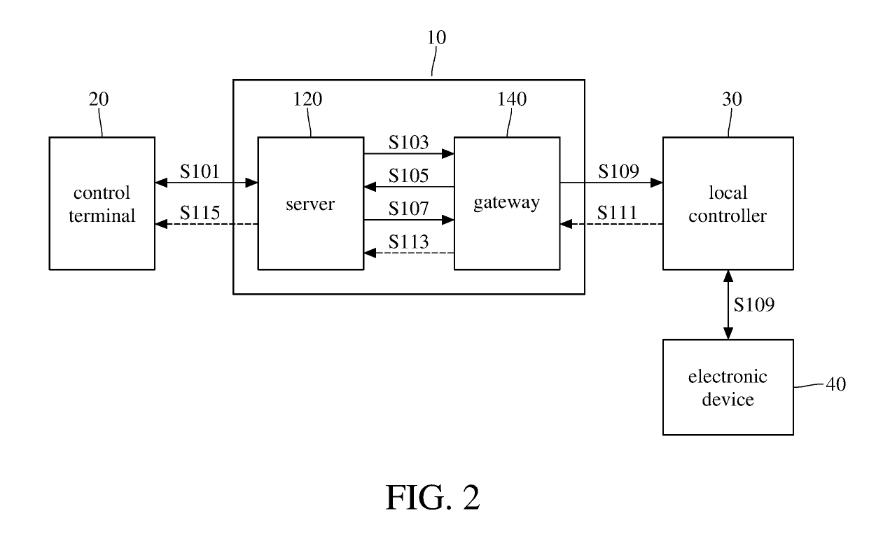

A detailed description of the operation of the control system is shown. FIG. 2 is a schematic diagram of the operation of the control system in accordance with an embodiment of the present disclosure. FIG. 2 shows steps from S101 to S111, and steps from S101 to S111 are respectively described below.

In step S101, the control terminal 20 establishes a link with the server 120. As mentioned above, the number of the control terminal 20 may be one or more. The control terminal 20 is, for example, a webpage of control interface provided by the server 120. The control terminal 20 provides control signals to the server 120 or obtains information from the server 120.

In step S103, the server 120 generates a second public key and a second private key randomly. The server 120 provides the second public key to the gateway 140. The second public key and the second private key belong to a same pair of keys. In an embodiment, when different control terminals 20 establish links with the server 120, the server 120 generates different second public keys and second private keys. That is to say, these different control terminals 20 will correspond to their respective pairs of keys. In other words, in such an embodiment, the server 120 adopts different encryption methods according to their respective control terminals 20.

In step S105, the gateway 140 generates a first public key and a first private key. The gateway 140 further provides the first public key to the server 120. The first public key and the first private key belong to a same pair of keys. That is, the first private key may be used to decrypt the information that is encrypted by the first public key. The first public key may be used to verify the information that is digitally signed by the first private key. In another embodiment, the server 120 at least has a second private key and a first public key. The gateway 140 at least has a second public key and a first private key. In an embodiment, when the server 120 provides the second public key to the gateway 140, the server 120 instructs the gateway 140 to proceed to the step S105.

In step S107, the server 120 encrypts the control signal that is provided by the control terminal 20 according to the first public key to generate the first encrypted signal. The server 120 provides the first encrypted signal to the gateway 140.

In step S109, the gateway 140 decrypts the first encrypted signal according to the first private key so as to obtain the control signal. Further, the gateway 140 instructs the local controller 30 to adjust the at least one parameter according to the obtained control signal. Alternatively, the gateway 140 obtains the at least one parameter of the local controller 30 according to the obtained control signal to generate a monitoring signal. In an embodiment, the gateway 140 instructs the local controller 30 to adjust the at least one parameter according to the obtained control signal. Further, the gateway 140 obtains the at least one parameter of the local controller 30 according to the control signal so as to generate a monitoring signal. In this way, the control terminal 20 can instantly see the result of the calibration. How to provide the at least one parameter to the control terminal 20 is described in detail below. When the gateway 140 obtains the at least one parameter of the local controller 30 according to the control signal to generate the monitoring signal, steps S111 to S115 are performed next.

In step S111, the local controller 30 provides the monitoring signal to the gateway 140.

In step S113, the gateway 140 encrypts the monitoring signal according to the second public key to generate a second encrypted signal. The gateway 140 encrypts the second encrypted signal according to the first private key so as to generate a digital signature signal. The gateway 140 provides the digital signature signal to the server 120.

In an embodiment, the gateway 140 is configured to compress the monitoring signal. Further, the gateway 140 is configured to encrypt the monitoring signal that has been compressed according to the second public key so as to generate a second encrypted signal. Later, the gateway 140 is configured to encrypt the second encrypted signal according to the first private key so as to generate a digital signature signal.

In step S115, the server 120 decrypts the digital signature signal according to the first public key so as to obtain the second encrypted signal, thereby verifying the digital signature. Besides, the server 120 is configured to decrypt the second encrypted signal according to the second private key to obtain the at least one parameter of the local controller 30. In an embodiment, when the gateway 140 generates the second encrypted signal according to the monitoring signal that has been compressed, the server 120 is configured to decrypt the second encrypted signal according to the second private key. Further, the server 120 is configured to decompress the second encrypted signal that has been decrypted so as to obtain the at least one parameter of the local controller 30.

In this embodiment, the server 120 obtains control signals from at least one control terminal 20 via the webpages of control interface, as described above. The server 120 is also configured to provide at least one retrieved parameter in chart ways via the webpages of control interface. In an embodiment, the server 120 stores the retrieved parameters for access by the control terminals 20. When the control terminal 20 instructs to read the current parameters of the local controller 30, the server 120 draws the current parameters into charts according to current read-out parameters or historical parameters along with the current parameters. The charts are provided to the control terminals via the webpages of control interface. But the scope of the disclosure does not limit on the type of charts, nor on the way in which the webpages of control interface are implemented.

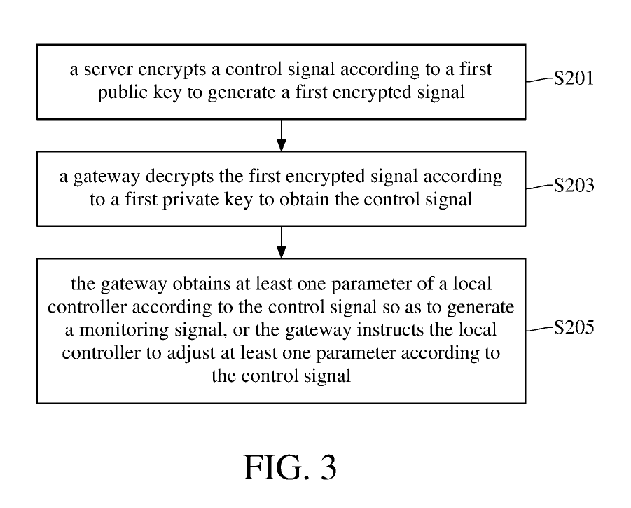

Based on the aforesaid embodiments, the present disclosure provides a control method, which may be adapted for a control system. The control system comprises a server and a gateway. Referring to FIG. 3, FIG. 3 is a flowchart illustrating a control method in accordance with an embodiment of the present disclosure. As shown in FIG. 3, in step S201, a control signal is encrypted by the server according to a first public key so as to generate a first encrypted signal. In step 5203, the first encrypted signal is decrypted by the gateway according to a first private key so as to obtain the control signal. In step 5205, at least one parameter of a local controller is obtained by the gateway according to the control signal so as to generate a monitoring signal. Or the local controller is instructed by the gateway to adjust at least one parameter according to the control signal.

In summary, the present disclosure provides a control system and a control method. A gateway communicates with a local controller via a controller area network (CAN) so as to conveniently access or adjust parameters. In addition, the key is used to encrypt the communication between the server and the gateway. On the other hand, the server also has webpages of control interface. In addition to providing graphical parameters for browsing, the webpages of control interface also allow multiple users to simultaneously operate local controllers. And for the users, it is similar to browse general webpages when using the webpages of control interface without cumbersome settings. Besides, since most of data processing is finished by the server, other electronic devices are mostly used for data transmission, which improves the processing efficiency of the control system. The parameters are graphically shown in real time. An instant and systematic control system with its control method is provided. The control system and the control method enhance the security of data transmission, which is quite practical.

It will be apparent to those skilled in the art that various modifications and variations can be made to the disclosed embodiments. It is intended that the specification and examples be considered as exemplary embodiments only, with a scope of the disclosure being indicated by the following claims and their equivalents.

What is claimed is:

1. A control system comprising:
a server, wherein the server is configured to encrypt a control signal according to a public key for generating a first encrypted signal; and
a gateway, wherein the gateway is electrically connected to a local controller, wherein the local controller controls an electronic device according to at least one parameter,
wherein the gateway is configured to communicate with the local controller via a controller area network,
the gateway is configured to decrypt the first encrypted signal according to a first private key for obtaining the control signal,
the gateway is configured to obtain the at least one parameter of the local controller for generating a monitoring signal according to the control signal,
or the gateway is configured to instruct the local controller for adjusting the at least one parameter according to the control signal,
wherein the first private key and the first public key belong to the same pair of keys.

2. The control system according to claim 1, wherein the gateway encrypts the monitoring signal according to a second public key so as to generate a second encrypted signal,
the gateway is configured to encrypt the second encrypted signal according to the first private key so as to generate a digital signature signal,
the server is configured to decrypt the digital signature signal according to the first public key to obtain the second encrypted signal,
and the server is configured to decrypt the second encrypted signal according to a second private key to obtain the at least one parameter of the local controller;
wherein the second private key and the second public key belong to a same second pair of keys.

3. The control system according to claim 2, wherein the gateway is configured to compress the monitoring signal,
wherein the gateway is configured to encrypt the monitoring signal that has been compressed according to the second public key to generate the second encrypted signal,
wherein the server is configured to decrypt the second encrypted signal according to the second private key, and
wherein the server is configured to decompress the second encrypted signal that has been decrypted so as to obtain the at least one parameter of the local controller.

4. The control system according to claim 2, wherein the server is configured to provide a webpage of control interface,
wherein the server is configured to obtain the control signal from at least one control terminal via the webpage of control interface, and the server is configured to provide the at least one parameter that has received in a chart way via the webpage of control interface.

5. The control system according to claim 4, wherein the server generates the second public key and the second private key when one of the at least one control terminal establishes a link with the server,
the server provides the second public key to the gateway,
the server instructs the gateway to generate the first public key and the first private key,
and the gateway provides the first public key to the server.

6. A control method applied to a control system having a server and a gateway, wherein the gateway is configured to communicate with a local controller via a controller area network, the control method comprising:
encrypting, by the server, a control signal according to a first public key for generating a first encrypted signal;
decrypting, the gateway, the first encrypted signal according to a first private key for obtaining the control signal; and
obtaining, the gateway, at least one parameter of the local controller according to the control signal for generating a monitoring signal, or instructing the local controller, by the gateway, to adjust the at least one parameter according to the control signal;
wherein the first private key and the first public key belong to a first same pair of keys.

7. The control method according to claim 6, further comprising:
encrypting, by the gateway, the monitoring signal according to a second public key to generate a second encrypted signal;
encrypting, by the gateway, the second encrypted signal according to the first private key to generate a digital signature signal;
decrypting, by the server, the digital signature signal according to the first public key to obtain the second encrypted signal; and
decrypting, by the server, the second encrypted signal according to a second private key to obtain the at least one parameter of the local controller;
wherein the second private key and the second public key belong to a same second pair of keys.

8. The control method according to claim 7, further comprising:
compressing, by the gateway, the monitoring signal;
encrypting, by the gateway, the monitor signal that has been compressed according to the second public key to generate the second encrypted signal;
decrypting, by the server, the second encrypted signal according to the second private key; and
decompressing, by the server, the second encrypted signal that has been decrypted to obtain the at least one parameter of the local controller.

9. The control method according to claim 7, wherein the server is configured to provide a webpage of control interface, the control method further comprising:
obtaining, by the server, the control signal from at least one control terminal via the webpage of control interface; and
providing, by the server, the at least one parameter that has received in a chart way via the webpage of control interface.

10. The control method according to claim 9, further comprising:
randomly generating, by the server, the second public key and the second private key when one of the at least one control terminal establishes a link with the server;
providing, by the server, the second public key to the gateway;
instructing the gateway, by the server, to generate the first public key and the first private key; and
providing, by the gateway, the first public key to the server.
